(19) United States
(12) Patent Application Publication
(10) Pub. No.: US 2021/0059256 A1
(43) Pub. Date: Mar. 4, 2021

(54) METHOD FOR CONTROLLING ROOT GROWTH USING GLUFOSINATE COMPOUNDS

(71) Applicant: Justin Fearn, Modesto, CA (US)

(72) Inventor: Justin Fearn, Modesto, CA (US)

(21) Appl. No.: 16/554,636

(22) Filed: Aug. 29, 2019

(51) Int. Cl. A01N 57/20; A01N 37/34

(52) U.S. Cl. CPC A01N 57/20; A01N 37/34

(57) ABSTRACT

The invention relates to the treatment of subterranean pipe works and other conduits to control plant root growth therein, novel compositions for use in the sewers to kill root growth therein, and novel and effective methods for application of such composition. The present invention particularly concerns compositions that include glufosinate, salts thereof, and/or derivates thereof and methods using such compositions for controlling root growth in subterranean pipes.

### FIELD OF THE INVENTION

The present invention relates to compositions and methods for controlling root growth by the application of novel root control compositions. Such compositions may include one or more glufosinate compounds, and optionally other active agents. Glufosinate has herbicidal properties, including toxicity to root tissue when locally applied. The present invention includes methods of applying compositions comprising glufosinate to prevent and reduce root growth in and around subterranean pipes.

### DISCUSSION OF THE BACKGROUND

Roots are naturally attracted to subterranean pipe systems such as sewers, storm drains, septic tank dispersion fields, drain fields for agricultural land, and water supply, as they present a source of water. Sewage lines and septic tank dispersion fields present a particular problem because of the high nutrient quality of the water going through them. This increases the tendency of the roots to penetrate the pipe joints and to grow within the pipe.

Many different approaches have been taken to root removal from such systems, including manual removal, chemical means, and physical means. None of the existing technologies have proven satisfactory. Some common older methods include passing common salts (e.g., sodium chloride, rock salt, copper sulfate, etc.) through the pipes in order dry out and kill the roots, or passing hot water through pipes to effectively boil and kill the roots. In some cases, the pipes may be taken up and the roots may be manually removed from the pipes. Some more modern methods, including chemical methods have been used in recent decades, as well.

There are a number of chemical products used to control vegetative root growth. However, the existing compositions and methods have drawbacks and inefficiencies. The most frequently used are 2.6 dichlorobenzonitrile (hereafter “Dichlobenil”), sodium methylidithiocarbamate (hereafter “Metam”), and diquat dibromide (hereafter “Diquat”). Dichlobenil is a common herbicide that acts upon growth points in root systems and therefore provides residual control by deterring regrowth. However, dichlobenil isn't effective for killing large, established roots. Metam is an agricultural general use pesticide used primarily as a broad spectrum pre-plant soil fumigant to control weeds, weed seeds, fungi, nematodes, and soil insects, but can also be used in root control. Diquat is a desiccant contact herbicide that dries out roots. Diquat cannot be used in combination with many other materials because it tightly binds to other materials, such as silicates and clays, organic matter, etc., and becomes inactive when this occurs. For example, diquat binds to ingredients commonly included in dichlobenil solutions and becomes inactive. Thus, diquat, is incompatible with many other root control herbicides that are known to improve efficacy.

Physical methods of root control are practiced as well. In some cases, the intruding roots may be bored out by “power snakes”. In other cases, steam and/or heated water has been employed as a means to control tree roots in sewers. Such techniques are typically practiced by plugging the downstream end of a sewer and filling it with heated water, or blowing stream through a closed off section of sewer. Controlling roots in sewers with heated water or steam is inefficient because it is time consuming (each individual root mass must be exposed to the heat source for several minutes), and involves substantial energy costs to heat such large volumes of water. Also, there is no lasting impact that would prevent roots from re-growing.

It is therefore desirable to have new devices, systems, and methods for controlling root growth.

### SUMMARY OF THE INVENTION

This invention relates to the treatment of subterranean pipe works and other conduits to control plant root growth therein, novel compositions for use in the sewers to kill root growth therein, and to novel effective methods for application of this composition. The present invention particularly concerns compositions that include glufosinate, salts thereof, and/or derivates thereof and methods using such compositions for controlling root growth in subterranean pipes.

The present invention relates to the use of root control compositions comprising glufosinate (dl-homoalanin-4-yl-(methyl)phosphinic acid) or a salt thereof (e.g., glufosinate ammonium, alkali glufosinate salts, etc.) or a derivate thereof (e.g., an N-alkyl, N-alkoxy, N-hydroxy, N-amino, N-aldehyde, N-ketone N-carbonyl, N-acetyl, β-alkyl, β-alkoxy, β-hydroxy, β-amino, β-aldehyde, β-ketone β-carbonyl, β-acetyl, and other derivatives) as a root control agent for use in and around sewer and other underground pipes. Glufosinate and its salts and derivatives may be effective as broad-spectrum systemic herbicides. The glufosinate inhibits glutamine synthetase by binding the glutamate site therein, whereby the production of glutamine is inhibited. This action results in reduced glutamine and elevated ammonia levels in tissues, halting photosynthesis, and tissue death.

Glufosinate compounds are contact herbicides, only affecting the parts of the plant which it contacts. Because glufosinate compounds are contact herbicides, they can be used for subterranean application because of its localized effect on growth around the area of application (e.g., underground pipes), avoiding harm to the above ground portions of plants. Glufosinate compounds have relatively low toxicity, providing a safer means of inhibiting root growth. Glufosinate compounds provide other benefits relative to materials currently used as root control agents. Diquat is incompatible with many foaming agents, whereas glufosinate is compatible with most foaming agents. Diquat is also incompatible with dichlobenil, whereas glufosinate compounds can be used with dichlobenil. Glufosinate compounds may also be used on all species of plant roots, are highly soluble in water, and are non-abrasive. Glufosinate compounds are also effective at much lower application rates than Metam, and are thus more economical. Glufosinate, and/or a salt or a derivate thereof may be present in the root control composition for application in a range of about 0.0001% by weight to about 5% by weight (e.g., about 0.001% by weight to about 2% by weight), or any value or range of values therein. In a concentrate solution for dilution to an applicable solution, the glufosinate, and/or a salt or a derivate thereof may be present in a range of about 5% by weight to about 50% by weight (e.g., about 15% by weight to about 40% by weight, about 20% by weight to about 30% by weight), or any value or range of values therein.

In some embodiments, the composition may include an effective amount of glufosinate, a salt thereof, and/or a derivative thereof and an effective amount of a root growth inhibitor. The combination of glufonsinate with a root growth inhibitor offers an effective means of killing roots in a targeted location (e.g., around sewer pipes), and preventing regrowth of the roots. For example, the composition may include glufosinate and an effective amount of dichlobenil as a growth inhibitor. In other examples, the root inhibitor may be a dinitroaniline, including benefin, oryzalin, pendimethalin, trifluralin, or combinations thereof; a pyridine, such as dithiopyr; 1-naphthaleneacetic acid (NAA); paclobutrazol, or combinations thereof. The root growth inhibitor may be in present in the composition in a range of about 0.0001% by weight to about 5% by weight (e.g., about 0.001% by weight to about 2% by weight), or any value or range of values therein. In a concentrate solution for dilution to an applicable solution, the root growth inhibitor may be present in a range of about 10% by weight to about 50% by weight (e.g., about 15% by weight to about 40% by weight, about 20% by weight to about 30% by weight), or any value or range of values therein.

The composition may further include binders or a foaming agent, which allows the composition to remain on pipe surfaces for an extended time, preventing new roots from entering the pipe. Surfactants may be used as a foaming agent for the present composition, and may include sodium lauryl ether sulfate (SLES), sodium lauryl sulfate (SDS), and ammonium lauryl sulfate (ALS), alkyl benzene sulfonate (ABS), polyethylene glycol sorbitan monolaurate (e.g., Tween-20™), non-ionic surfactants (e.g., alkyl polyglycosides (APGs)), and other common surfactants. In some embodiments, the surfactant may include alkyl aryl polyether alcohols and/or ethers thereof, such as an octylphenoxyethanol (e.g., Triton X-100™), a nonyl phenoxy polyoxyethylene ethanol (Retzanol NPIOU™), and/or a nonyl phenyl polyethylene glycol ether (e.g., Tergitol NPX™). The surfactant may be present in amounts of about 0.5% by weight to about 15% by weight of the composition (e.g., about 3% to about 12% by weight, about 5% to about 10% by weight), or any value or range of values therein.

In some embodiments, the composition may be a viscous composition that is operable to adhere to the targeted roots and thus may be sprayed thereon and effectively remain on the roots to deliver the active ingredients of the composition. In such embodiments, the composition may further comprises a thickening agent such as a polysaccharide gum (e.g., xanthan gum), colloidal clays, alginates, acrylates, vinyl ethers, and substituted cellulose derivatives, such as hydroxyethylcellulose (HEC). In another embodiment of the invention, the thickener may be present in an amount of from about 0.001 by weight to about 0.1 by weight (e.g., about 0.01 by weight to about 0.05 by weight), or any value or range of values therein.

The compositions of the present invention may also include adjuvants which act as carriers, facilitate the removal of organic substances, improve the ability of the active ingredients to adhere or penetrate root tissue, or otherwise improve the efficacy of the treatment, including, but not limited to, degreasers, emulsifiers, wetting agents, penetrants, spreaders, and sticking agents.

A preferred concentrate formulation may include about 25 to 35% glufosinate w/w, about 15% to about 25% w/w of dichlobenil as a growth inhibitor, and about 5% to about 15% w/w of a surfactant, and water at about 25% to about 55% w/w. This composition may be a concentrate aqueous solution that can be diluted in water such that the applied solution provides glufosinate at about 0.001% w/w to about 2% w/w (e.g., about 0.0025 w/w and about 0.8% w/w) and dichlobenil at about 0.001% w/w to about 2% w/w (e.g., about 0.005 w/w to about 1% w/w).

The composition may be applied to roots within a targeted pipe via a hydraulic sewer cleaning machine (e.g., a sewer jetter style apparatus). Such an apparatus pumps water through a hose at high pressure through a nozzle having a body divided by a pressure-actuated valve where high pressure water can be applied to the nozzle in such a way as to cause a propelling jet to issue from the rear of the nozzle. The jets of water issuing from the nozzle serve to propel the nozzle and its water-supplying hose along a pipe and at the same time to unreel the hose for some predetermined length. In some embodiments of the present invention, the root control compositions may be directly applied via the sewer cleaning machine as a high pressure spray which dispenses the composition and may also clear away debris that could block flow in sewer pipes. In such embodiments, a high pressure water spray may first be used to create a path through the root growth in the targeted pipe. The root control composition may subsequently be passed through the hose and nozzle of the machine to coat the roots and the targeted pipe. In such embodiments, the hydraulic sewer cleaning machine may deliver the root control composition at pressures in a range of about 300 PSI to about 3000 PSI (e.g., about 500 gallons per minute to about 2000 gallons per minute), or any value or range of values therein. The machine may also deliver the root control composition in volumes of about 10 gallons per minute to about 20 gallons per minute (e.g., about 12 gallons per minute to about 15 gallons per minute), or any value or range of values therein.

In some embodiments, the root control composition may include a foaming or thickening agent and may be sprayed onto the pipe walls through the hose and nozzle of the hydraulic sewer cleaning machine. The removal of the roots may be significantly enhanced by exposing the roots to the active agents in the composition for an extended period of time. The foaming or thickening agent may allow the root control composition to stick to and maintain contact with the targeted roots. The foaming or viscous composition may cling sufficiently to the targeted roots rather than flowing off, thereby providing enhanced efficacy.

In some embodiments, the foaming composition may be conditioned into a foam using a conventional foam generating machine. Such foaming machines are operable to incorporate a large amount of air into the composition (e.g. up to about 80% by volume) to generate a foamy consistency. The foam may be formed by mixing the composition with water and air in metered amounts to provide the proper proportions to provide a damp, frothy foam. The high-pressure supply of water may first be used to create a path through the root growth. The foamed root control composition may then be introduced into the hose or pump system of the sewer cleaning machine, and pumped through the nozzle into the targeted pipe and onto the roots therein. In some examples, the foaming composition may be applied by filling the targeted pipe with the composition. The foaming composition may reduce the loss of active material than filling the pipe with a liquid solution because (1) the foam contains about twenty times as much air as liquid composition, and (2) much of the foam clings to the targeted roots, and only a portion washes away.

In still other embodiments, the foaming or viscous composition may be applied to exposed roots, the exterior of a pipe, and/or the soil surrounding the pipe by a spraying mechanism. For example, a hydraulic pump sprayer may be used to pass the foaming or viscous composition through a hose and spray nozzle system. The nozzle passages may be enlarged for the viscous root control composition. For example, the viscous root control composition may have a viscosity in a range of about 20 centipoise (cps) to about 200 cps (e.g., about 30 cps to about 80 cps), or any value or range of values therein. Thus, a nozzle with larger passage opens allow better flow and less clogging of the spray nozzle system. The nozzle holes may be enlarged relative to a sewer jetter nozzle by 1.5 to 2.5 times, resulting a nozzle passage size in a range of about 1.5 mm to about 2.5 mm.

In some embodiments of the invention, the root control composition may be heated to create may be applied a hot water or steam condition of the composition that is delivered via the sewer cleaning machine. Hot water may be an effective medium because it has a neutral pH, and it is a natural way to prepare roots for treatment. Hot water spray essentially cleans roots of debris and grease faster and more efficiently than cold water and/or chemical surfactants. Additionally, the herbicidal effect of the heat itself may assist the chemical agents to control root growth. Concentrations of the active ingredients of the root treatment composition in hot water may be the same as for other applications. The water in the root treatment composition may be heated to a temperature of about 170° F. or more. Higher water temperatures may be used to provide better cleaning, better degreasing, increased herbicide volatilization, and an enhanced herbicidal effect. Glufosinate has an advantage over other herbicides with respect to its use in hot water applications. Other herbicides or root growth agents volatilize or transform to other chemical byproducts in hot water and may cause the treatment to be ineffective or hazardous. In examples using hot water, the hydraulic sewer cleaning machine may operate at lower pressures (e.g., 300 PSI or less) and volumes (e.g., 2 gallons of water per minute or less). For example, the solution may be pumped into the pipe at about 1.5 gallons of solution per minute.

The compositions and methods of the present invention result in non-systemic effects on the treated plants, thus avoiding harm to the plants outside of the targeted roots. The compositions and methods of the present invention may also provide the benefit of reducing fungal and bacterial growth in the targeted pipes. Additionally, fungal, algal and bacterial slimes and deposits may be effectively emulsified and dispersed into the waste water flow and carried out of the targeted pipe. Thus, the present invention provides an efficient and effective solution to sewer pipe contamination with roots and other biological contamination.

Example embodiments of the present invention are provided below. However, they are exemplary and they do not limit the scope of the present invention.

In one aspect, the present invention relates to a method of controlling root growth in and around subterranean pipe works, comprising applying a root control composition comprising an effective amount of a glufosinate, a salt thereof, and/or a derivative thereof to roots present in or around a pipe. The root control composition may further comprise a root growth inhibitor. The root growth inhibitor may comprise dichlobenil. The root growth inhibitor may be selected from the group consisting of dichlobenil, a dinitroaniline, a pyridine, 1-naphthaleneacetic acid (NAA); paclobutrazol, or combinations thereof. Dichlobenil may be present in said root control composition in a range of about 0.001% w/w to about 2% w/w. The glufosinate, a salt thereof, and/or a derivative thereof may be present in said root control composition in a range of about 0.001% w/w to about 2% w/w. The root control composition is applied to the exposed root as a foam. The root control composition may comprise a surfactant as a foaming agent. The root control composition may be applied to the exposed root as a viscous liquid having a thickening agent therein. The root control composition may be applied to the exposed root as a spray. The root control composition may be heated to a temperature greater than 150° F. prior being sprayed on the roots present in or around the pipe.

In another aspect, the present invention relates to a method of controlling root growth in and around subterranean pipe works, comprising applying a root control composition comprising an effective amount of glufosinate, a salt thereof, and/or a derivative thereof and a root growth inhibitor to roots present in or around a pipe. The root growth inhibitor may comprise dichlobenil. The root growth inhibitor may be selected from the group consisting of dichlobenil, a dinitroaniline, a pyridine, 1-naphthaleneacetic acid (NAA); paclobutrazol, or combinations thereof. Dichlobenil may be present in said root control composition in a range of about 0.001% w/w to about 2% w/w. The glufosinate, a salt thereof, and/or a derivative thereof may be present in said root control composition in a range of about 0.001% w/w to about 2% w/w. The root control composition is applied to the exposed root as a foam. The root control composition may comprise a surfactant as a foaming agent. The root control composition may be applied to the exposed root as a viscous liquid having a thickening agent therein. The root control composition may be applied to the exposed root as a spray. The root control composition may be heated to a temperature greater than 150° F. prior being sprayed on the roots present in or around the pipe.

In another aspect, the present invention relates to a root control composition for controlling root growth comprising an effective amount of a glufosinate, salts thereof, and/or derivates thereof to roots present in or around a pipe. The root control composition may further comprise a root growth inhibitor. The root growth inhibitor may comprise dichlobenil. The root growth inhibitor may be selected from the group consisting of dichlobenil, a dinitroaniline, a pyridine, 1-naphthaleneacetic acid (NAA); paclobutrazol, or combinations thereof. Dichlobenil may be present in said root control composition in a range of about 0.001% w/w to about 2% w/w. The glufosinate, a salt thereof, and/or a derivative thereof may be present in said root control composition in a range of about 0.001% w/w to about 2% w/w. The root control composition may further comprise a foaming agent. The root control composition may further comprise a surfactant as a foaming agent. The root control composition may further comprise a thickening agent. The root control composition may be a concentrate for dilution prior to application. The concentrate may include glufosinate, and/or a salt or a derivate thereof in a range of about 10% by weight to about 40% by weight. The concentrate may include the root growth inhibitor in a range of about 10% by weight to about 40% by weight.

It is an object of the present invention to provide improved compositions and methods for controlling root growth in and around underground pipe works.

It is an object of the present invention to provide environmentally friendly and efficient root control methods.

It is an object of the present invention to provide root control compositions that are operable to target only specific parts of a plant (e.g., roots) without killing off the entire plant.

The above-described objects, advantages and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 shows a method of applying a root control composition according to an embodiment of the present invention.

FIG. 2 shows a perspective view of an exemplary hydraulic sewer cleaning machine according to an embodiment of the present invention.

### DETAILED DESCRIPTION OF THE EXEMPLARY EMBODIMENTS

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

The present invention provides for a method for destroying plant root tissue in a targeted, localized area, comprising applying to the tissue an effective amount of glufosinate, a glufosinate salt, and/or a glufosinate derivate. In some examples, the root control composition may include glufosinate-ammonium, the scientific name of which is 2-amino-4-(hydroxymethylphosphinyl)butanoic acid monoammonium salt, and which has the chemical structure:

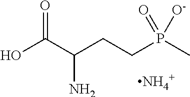

Glufosinate, a glufosinate salt, and/or a glufosinate derivate may be incorporated into a root treatment composition that includes additional functional agents. The applied root treatment composition may include glufosinate, a glufosinate salt, and/or a glufosinate derivate in a concentration of between about 0.0001% w/w to about 5% w/w (e.g., about 0.001% w/w to about 2% w/w, about 0.0025 w/w and about 1 percent w/w), or other ranges therein). Such solutions may further comprise other agents, such as a root growth inhibitor, such as dichlobenil, at effective concentrations. The root growth inhibitor may be present in said root control composition in a concentration of about 0.001% w/w to about 2% w/w. Such solutions may also comprise adjuvants such as a surfactant to facilitate foaming, a thickening agent to increase viscosity of the composition, and/or other agents to improve the adherence and penetration of the active agents, such as emulsifiers, wetting agents, penetrants, spreaders, and sticking agents.

The root treatment composition may be applied as a solution as a pressurized spray. In some embodiments, the root treatment composition may be applied to exposed roots as a foam. For example, the root treatment composition may be mixed with water and surfactant, which acts as a foaming agent. In other embodiments, the root treatment composition may be a viscous solution comprising a thickening agent. The root treatment composition may be delivered into a subterranean pipe using a hydraulic sewer cleaning system that includes at least a tank, a pumping system, and a delivery mechanism.

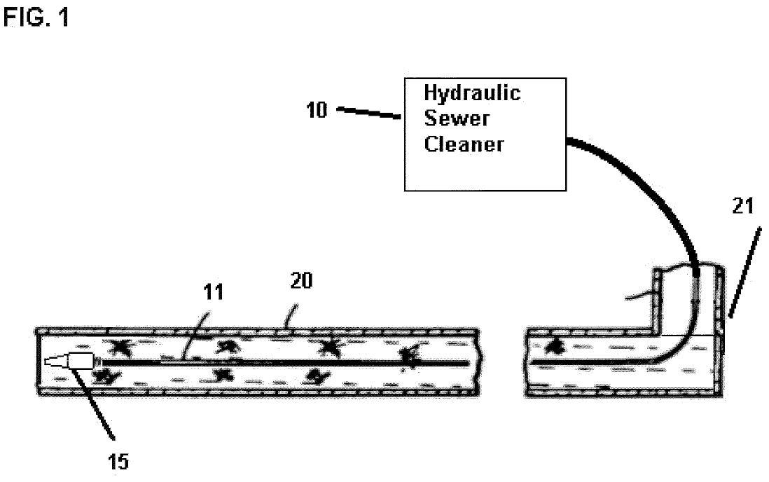

As shown in FIG. 1, an application hose 11 may be placed within a subterranean pipe 20 (e.g., into a sewer pipe), from a first end of the pipe 21 to the other. A hydraulic sewer cleaning machine 10 may be used to apply the root treatment composition into the pipe 20. The delivery hose 11 may be delivered into the pipe by manual introduction. A high-pressure nozzle 15 may be present on the distal end of the delivery hose 11, which may be operable to deliver the root treatment composition in radiating sprays that provide 360° coverage of the surrounding roots and pipe. The angle of the nozzle apertures may be rearward facing, such that the jets of fluid emitted by the nozzle propel the nozzle 15 and the delivery hose 11 forward through the pipe 20.

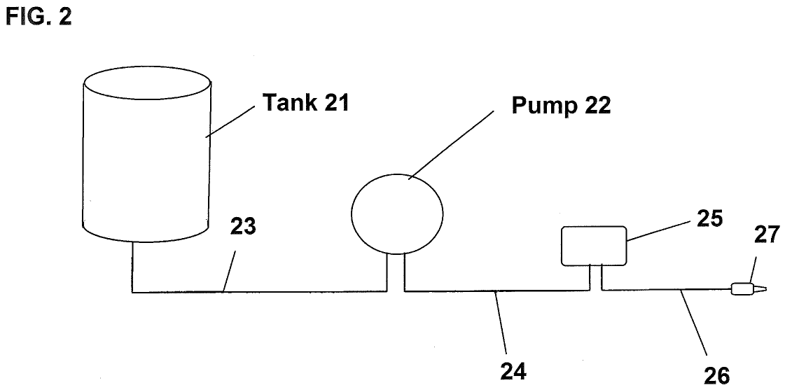

An exemplary hydraulic sewer cleaning machine used to deliver the root treatment composition is depicted in FIG. 2. FIG. 2 provides a schematic diagram of the machine, including a tank 21 in which the root control composition may be housed, a high pressure pump 22 connected to the tank by a feeder hose 23, and the high pressure pump is able to pump water through a pressure line 24 to a hose reel 25 connected to a delivery hose 26 having a jet nozzle 27. The root control composition of root control agent is introduced into the tank 21 connected to the feeder hose 23 via a valve. The nozzle may be located at the free end of the delivery hose 26. The nozzle may have multiple rearward facing ports which eject fluid so as to propel the nozzle and hose forward. The nozzle may be a spinning nozzle, which may provide better coverage of the root control composition within the pipe. The spinning nozzle may provide a side ports that jet radiating streams of water in a direction approximately perpendicular to the pipe wall. The radiating jets of water from the side port causes the nozzle body to spin, thereby causing the direction of the spray to rotate, thereby widely distributing root control composition over the inner surface of the pipe. In further examples, the nozzle may be equipped with spray ports designed to atomize the root control composition, which may minimize droplet size, and reduce run-off.

Compressed air may be injected into a stream of the root treatment composition as it is being pumped, in order to create a foam. The foam composition may be introduced into a hydraulic sewer cleaning machine pump system into tank 21 or may be delivered into the delivery hose 26 of the machine to be propelled by pressurized water in the delivery hose 26. Alternatively, the root treatment composition may be conditioned into a foam by a conventional foam generating machine. The foam may be delivered under pressure to fill the targeted pipe. The filling capability may be optimized by altering the rate at which the application hose is retrieved. In order to fill a pipe with foam, the application hose may be retrieved at a rate (feet per minute) equal to the gallons of foam generated per minute divided by the volume (gallons per foot of length) of pipe.

As a non-limiting example of the invention, the foaming agent may have an expansion ratio of 20 to 1 when applied at a rate which utilizes 4.5 gallons of solution per minute, which therefore produces 90 gallons of foam per minute (4.5 gallons×20). The volume of an 8 inch diameter pipe is approximately 2.6 gallons per foot of length. At an application rate of 90 gallons of foam per minute in an 8 inch diameter pipe, the hose should be retrieved at a rate of approximately 35 feet per minute (90 gallons/minute-2.6 gallons per foot=35 feet per minute). As another non-limiting example, the foaming compound may provide a lower expansion ratio, e.g., 15 to 1, and the foam may be applied at a lower rate, e.g., 3.5 gallons per minute. In such examples, the hose may eject approximately 53 gallons of foam per minute (3.5×15=53). If the pipe to be treated is 10″ in diameter, the volume of the pipe is approximately 4 gallons per foot. The hose retrieval rate in this example would be approximately 13 feet per minute (53 gallons per minute−4 gallons per foot=13.25).

In another non-limiting example, the flow in large diameter pipes (e.g., 15″ and greater) may overpower the foam such that it cannot fill the pipe and remain in place. This condition may be addressed by applying a 3″ to 4″ coating of foam along the entire inside circumference of the pipe. The volume of foam required to coat a pipe may be calculated by determining the volume of the pipe to be treated (per foot), and subtracting from that the volume of a pipe 6 to 8 inches smaller in diameter (per foot).

### CONCLUSION/SUMMARY

The present invention thusly provides compositions and methods for killing off roots that invade and/or surround subterranean pipe works. It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. Thus, although reference has been made to the accompanying figures, it is to be appreciated that these figures are exemplary and are not meant to limit the scope of the invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method of controlling root growth in and around subterranean pipe works, comprising applying a root control composition comprising an effective amount of a glufosinate, a salt thereof, and/or a derivative thereof to roots present in or around a pipe.

2. The method of claim 1, wherein the root control composition further comprises a root growth inhibitor.

3. The method of claim 2, wherein the root growth inhibitor comprises dichlobenil.

4. The method of claim 2, wherein the root growth inhibitor is selected from the group consisting of dichlobenil, a dinitroaniline, a pyridine, 1-naphthaleneacetic acid (NAA); paclobutrazol, or combinations thereof.

5. The method of claim 3, wherein the dichlobenil is present in said root control composition in a range of about 0.0001% w/w to about 5% w/w.

6. (canceled)

7. The composition of claim 1, wherein the glufosinate, a salt thereof, and/or a derivative thereof is present in said root control composition in a range of about 0.0001% w/w to about 5% w/w.

8. (canceled)

9. The method of claim 1, wherein the root control composition is applied to the exposed root as a foam, and the root control composition comprises a surfactant as a foaming agent.

10. (canceled)

11. The method of claim 1, wherein the root control composition is applied to the exposed root as a viscous liquid having a thickening agent therein.

12. (canceled)

13. (canceled)

14. A method of controlling root growth in and around subterranean pipe works, comprising applying a root control composition comprising an effective amount of a glufosinate, a salt thereof, and/or a derivative thereof and a root growth inhibitor to roots present in or around a pipe.

15. The method of claim 14, wherein the root growth inhibitor comprises dichlobenil.

16. The method of claim 14, wherein the root growth inhibitor is selected from the group consisting of dichlobenil, a dinitroaniline, a pyridine, 1-naphthaleneacetic acid (NAA); paclobutrazol, or combinations thereof.

17. The method of claim 15, wherein the dichlobenil is present in said root control composition in a range of about 0.0001% w/w to about 5% w/w.

18. (canceled)

19. The composition of claim 14, wherein the glufosinate, a salt thereof, and/or a derivative thereof is present in said root control composition in a range of about 0.0001% w/w to about 5% w/w.

20. (canceled)

21. The method of claim 14, wherein the root control composition is applied to the exposed root as a foam, and the root control composition comprises a surfactant as a foaming agent.

22. (canceled)

23. (canceled)

24. (canceled)

25. (canceled)

26. A root control composition for controlling root growth comprising:
a. a glufosinate, a salt thereof, and/or a derivative thereof in said root control composition in a range of about 0.0001% w/w to about 5% w/w;
b. a root growth inhibitor present in said root control composition in a range of about 0.0001% w/w to about 5% w/w;
c. a foaming agent.

27. (canceled)

28. The composition of claim 26, wherein the root growth inhibitor comprises dichlobenil.

29. The composition of claim 26, wherein the root growth inhibitor is selected from the group consisting of dichlobenil, a dinitroaniline, a pyridine, 1-naphthaleneacetic acid (NAA); paclobutrazol, or combinations thereof.

30. (canceled)

31. The composition of claim 26, wherein said root growth inhibitor is present in said root control composition in a range of about 0.001% w/w to about 2% w/w.

32. (canceled)

33. The composition of claim 26, wherein said glufosinate, a salt thereof, and/or a derivative thereof is present in said root control composition in a range of about 0.001% w/w to about 2% w/w.

34. (canceled)

35. (canceled)

36. (canceled)

37. The composition of claim 26, wherein the root control composition is a concentrate for dilution prior to application, wherein the concentrate includes glufosinate, and/or a salt or a derivate thereof in a range of about 10% by weight to about 50% by weight and the concentrate includes the root growth inhibitor in a range of about 10% by weight to about 50% by weight.

38. (canceled)

39. (canceled)
